(19) United States
(12) Patent Application Publication
(10) Pub. No.: US 2007/0244825 A1
(43) Pub. Date: Oct. 18, 2007

(54) Item, accessory kit, and method for software based medical resource activation

(76) Inventors: Gilbert Semmer, Freiburg (DE); Shane MacNamara, Ebringen (DE); Jose Moctezuma de la Barrera, Freiburg (DE)

Correspondence Address: MCCRACKEN & FRANK LLP, 200 W. ADAMS STREET, SUITE 2150, CHICAGO, IL, 60606, US

(21) Appl. No.: 11/404,320

(22) Filed: Apr. 14, 2006

(51) Int. Cl. G06Q 50/00

(52) U.S. Cl. 705/59

(57) ABSTRACT

An accessory kit for use with a software based medical resource to perform a particular medical procedure includes a package, a license media that includes license key information, a package and an item for use in performing the medical procedure. The method includes the steps of obtaining a license key from a license media, using the key to activate a medical resource, and writing data back to the license media to disable the license key so that the license key can not be reused. One type of license media used is an RFID tag.

### CROSS REFERENCE TO RELATED APPLICATIONS

Not applicable

### REFERENCE REGARDING FEDERALLY SPONSORED RESEARCH OR DEVELOPMENT

Not applicable

### SEQUENTIAL LISTING

Not applicable

### BACKGROUND OF THE INVENTION

1. Field of the Invention

This invention relates to an accessory kit and a method for software based medical resources. More particularly, this invention relates to an accessory kit that includes licensing media for allowing use of the software based medical resource, such as a surgical navigation system, for a particular procedure in addition to other items needed for that particular procedure.

2. Description of the Background of the Invention

As surgical systems for performing procedures and equipment to implement or assist in performing these procedures become more complicated and specialized, the cost for hospitals to acquire and maintain multiple systems and devices to assist in performing a wide range of procedures becomes a burden on the health care systems of the country. One method of minimizing cost is to limit the number of systems that are purchased or to share more expensive systems. This creates issues where the patient is in one location but the equipment or resource needed to perform a procedure is in a different hospital or even a different city.

This can even become an issue within a single hospital system. In particular, some surgical suites can be set up for particular specialized surgeries. This can have its efficiencies but this can become a bottleneck to the efficient administration and delivery of health care when general purpose equipment is used with specialized software that has been loaded into only a single device because of licensing constraints.

Many systems and resources that are used to assist in the performance of medical or surgical procedures have software as a significant component of the system. These systems may include some specialized hardware components but in a typical situation, the primary limitation on the shared use of these computer based medical systems is the licensing of the software used to manage and run these systems. Even systems that may share hardware components often only include the software for certain specialized applications. In certain situations, the medical resource is a computer that has specialize software loaded onto the computer. Examples of a software system of this type are a surgical planning system that assists a surgeon in preplanning a particular surgical procedure using pre-surgical scans and other diagnostic tools, and expert systems that guide a user, such as a surgeon, through a complex procedure, including alternate procedures for situations that the user encounters during the procedure.

In addition, the hospitals need to recover their fixed costs for acquiring and maintain these varied systems. If a system or resource sits idle for any significant amount of time, the hospital cannot afford to maintain this system or resource. This could result in patients going to other hospitals and facilities that have the appropriate resources available. There can also be situations where on one particular day, three surgical suites will need systems for a variety of orthopedic procedures but on a subsequent day there will be the need for these same three surgical suites to perform neurological procedures. The cost to the hospital to have available three systems to simultaneously perform three procedures while at the same time there are a similar number of other systems sitting idle on that day is significant.

In addition, most surgical procedures require certain predefined consumable or disposable items. These items are typically used a single time and are either consumed during the procedure, or are disposable so that the risk of cross contamination is minimized.

There have been proposals for pay as you go systems for a variety of medical devices. These prior systems allowed a hospital or other health care facility understand the particular costs associated with a procedure or the use of a particular piece of equipment and pass those costs directly on to the patient. Other metering scenarios include the use of counters or meters on items that have a limited useful life such as like drill bits and saw blades so that these items are only used a surgically acceptable number of times. Other systems require the resource be connected to a network so that the licensing information can be verified.

### SUMMARY OF THE INVENTION

One embodiment of the present invention is an accessory kit for use with a software based medical resource to perform a particular medical procedure on a patient. The accessory kit includes a package; an item for use in performing the particular medical procedure packaged within the package; and a license media containing a license key that enables a user to use the medical resource to perform the particular medical procedure on the patient that includes using the item associated with the procedure, the license media packaged within the package.

A further embodiment of the present invention is an item for use with a software based medical resource to perform a particular medical procedure. The item includes a license media that contains a license key to enable a user to use the medical resource to perform the particular medical procedure on the patient that includes using the item.

A still further embodiment of the present invention relates to a method of licensing the use of a software based medical resource to perform a particular procedure The method includes the steps of obtaining a license key from a license media; using the key to activate a medical resource; and writing data back to the license media to disable the license key so that the license key can not be reused.

Other aspects and advantages of the present invention will become apparent upon consideration of the following detailed description.

### BRIEF DESCRIPTION OF THE DRAWINGS

FIG. 1 is a plan view of an accessory kit according to one aspect of the invention;

FIG. 2 is a schematic view of a surgical navigation system according to one aspect of the present invention that has been set up to perform a total hip replacement;

FIG. 3 is a plan view of one embodiment of a license key according to the present invention;

FIG. 4 is a cross-sectional view of the license key of FIG. 3 generally taken along line 4-4 in FIG. 3;

FIG. 5 is a plan view of the accessory kit of FIG. 1 after the kit has been opened;

FIG. 6 is a plan view of an opened accessory kit according to a second embodiment of the present invention;

FIG. 7 is a plan view of an opened accessory kit according to a third embodiment of the present invention;

FIG. 8 is a flow diagram of one embodiment of the method of the present invention;

FIG. 9 is a flow diagram of another embodiment of the method of the present invention;

FIG. 10 is a flow diagram of a further embodiment of the method of the present invention; and

FIG. 11 is a perspective diagrammatic view of items according another aspect of the present invention.

### DETAILED DESCRIPTION OF THE DRAWINGS

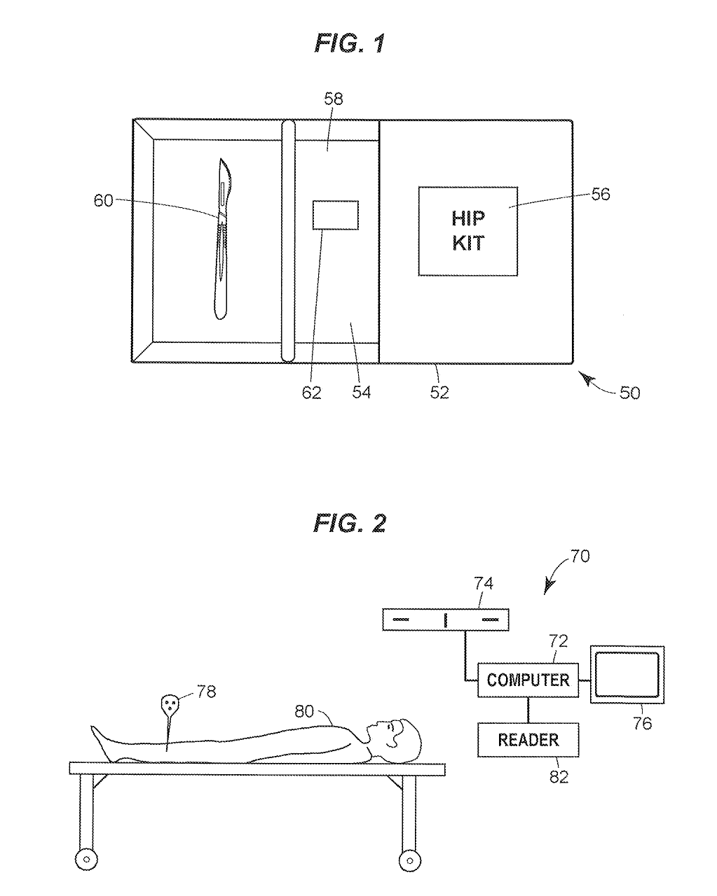

FIGS. 1 and 2 show an accessory kit 50 that has a package 52 with a removable cover 54. Depending on the nature of the medical device and the chosen medical procedure, the package 52 may be made available in a sterile condition because some of the components that form the accessory kit 50 will be used within a surgical environment and may actually come in contact with the patient. For other situations, it will not be necessary to have the package 52 sterilized. The removable cover 54 typically will include an informative label 56 that will identify the nature of the accessory kit 50. The removable cover 54 also may optionally include a see through area 58 so that some elements of the accessory kit 50 may be visible to the user before the package 52 has been opened. In the embodiment as shown, the accessory kit 50 includes a scalpel 60 and a radio frequency identification (RFID) tag 62. The data stored within the RFID tag 62 includes a license key, as well as other useful information including data identifying the particular RFID tag 62 and data specific to the medical resource. It also is possible to write data to the RFID tag 62. This includes patient information, data relating to the procedure, and data indicating that the license key has been used. Also, it should be possible to write protect the RFID tag 62 so that when the data that indicates that the license key has been used is written to the RFID tag 62, that data cannot be removed to enable the RFID tag 62 could be used again to activate another medical resource. The stored license key can be stored in a variety of formats well known to those of skill in the art. In one environment, the license key stored within the RFID tag 62 will be encrypted using a suitable encryption algorithm. The specifics of recovering the license key from the RFID tag 62 will be discussed hereinafter. In addition to the scalpel 60 and the RFID tag 62, other components, typically disposable components, for the particular surgical or medical procedure may also be included within the accessory kit. The RFID tag 62 will be used to enable a particular device as will be discussed in more detail hereinafter.

FIG. 2 shows a typical arrangement of one type of medical resource that is software based that might be useful with the accessory kits and methods of the present invention, namely a surgical navigation system 70. The surgical navigation system 70 includes a computer 72, a camera 74, typically including multiple CCD arrays (not shown), and a display 76. In addition, the surgical navigation system 70 also uses a series of tracking devices 78 that are typically affixed to a patient 80 who is undergoing a particular medical procedure. The computer 72 will include software loaded within memory (not shown) that will drive the camera 74 and enable the computer 72 to follow the location of the tracking device(s) 78. In addition, the software will frequently guide the user of the surgical navigation system 70 through the steps of a particular procedure. As noted before, it is desirable that a medical facility maximize the use of its facilities. To that end, the computer 72 can be preloaded with software for a wide variety of medical procedures that use, for instance a surgical navigation system 70 or some other medical device that is readily available to the surgical suite or procedure room. The embodiment of the surgical navigation system 70 will be used as an example of the software based medical resource in the description that follows. This description is not meant to limit the present invention to this particular embodiment. The present invention can be used with a wide variety of software based medical resources, including a stand alone computer loaded with specialized software to assist in a medical procedure or in planning for a medical procedure, expert systems and databases to guide a medical team, and other medical and surgical equipment that employs software control.

The user after opening the accessory kit 50 will use the RFID tag 62 to activate a particular program within the computer 72 so that computer 72 can be fully used to assist in performing the desired procedure. In particular, the computer 72 will read data from the RFID tag 62 into memory of the computer 72. This data includes the license key contained on the RFID tag 62 and possibly other information and data about the particular procedure that has been chosen that is associated with the RFID tag 62. Also, the computer 72 can write data directly to the RFID tag 62. This information can include details about the patient, the time and place of the procedure, and other useful information that should be captured. Also, the computer will determine if the RFID tag 62 has been write protected. If the RFID tag 62 does not include data indicating that the license key has been used, the computer 72 will notify the user that a license is available for use on the RFID tag 62, and ask the user if the user wants to activate or use the license to perform a particular procedure. If the user indicates that the available license key should be used, the computer 72 will write data to the RFID tag 62 that indicates that the license key has been used. This data might also include the time and date the key was used and other information as well. After the computer 72 has written this data to the RFID tag 62, the computer 72 will write protect the RFID tag 62 using known methods and procedures. If the computer 72 reads the data on the RFID tag 62 and the data indicates that the license key had been previously used, the computer 72 will display a warning to the user that no license is available. In this later case, the RFID tag 62 will have been write protected to protect the data indicating that the license key had been previously used.

In one embodiment of the present invention, the RFID tag 62 will include encrypted data relating to the license key and this data will also be tied to the identity of the particular RFID tag 62 upon which that license key data had been originally written. The software that is loaded within memory of the computer 72 will include an authentication code that will compare the encrypted license key information with the identity of the RFID tag 62. The authentication code will only allow a user to activate a license key that is resident on the RFID tag 62 that matches the identity of the RFID tag 62 that is identified in the license key data.

In addition, the accessory kit 50 will include items that are useful in performing the desired procedure on the patient 80. The computer 72 will include an RFID tag read write device 82 that can both read the information stored within the RFID tag 62 and write data back to the RFID tag 62. Technology to provide the RFID tag read write device 82 is well known in the art and will not be set out in detail. The RFID tag read write device 82 for the RFID tag 62 will typically include an antenna, a data matching algorithm, and a mechanism to transfer data to the computer 72 based on the identity of the data within the RFID tag 62, as well as the ability to transfer data back to the RFID tag 62 that can write patient or procedure specific or other information to the RFID tag 62 and also to write protect and thereby disable the RFID tag 62 so that the license key contained within the RFID tag 62 cannot be used to activate a subsequent procedure. Depending upon the environment, the computer 72 will only activate the procedure identified with the license key if the data on the RFID tag 62 does not indicate that the license key has been activated and if the RFID tag 62 has not been write protected. This will prevent the situation where a user write protects the RFID tag 62 before the license key has been activated to attempt to prevent the computer 72 writing data back to the RFID tag 62 that indicates that the license key has been activated. In this environment, the computer 72 will only activate the license key if both the RFID tag 62 can be written to and the RFID tag 62 does not contain data that indicates that the license key has been used.

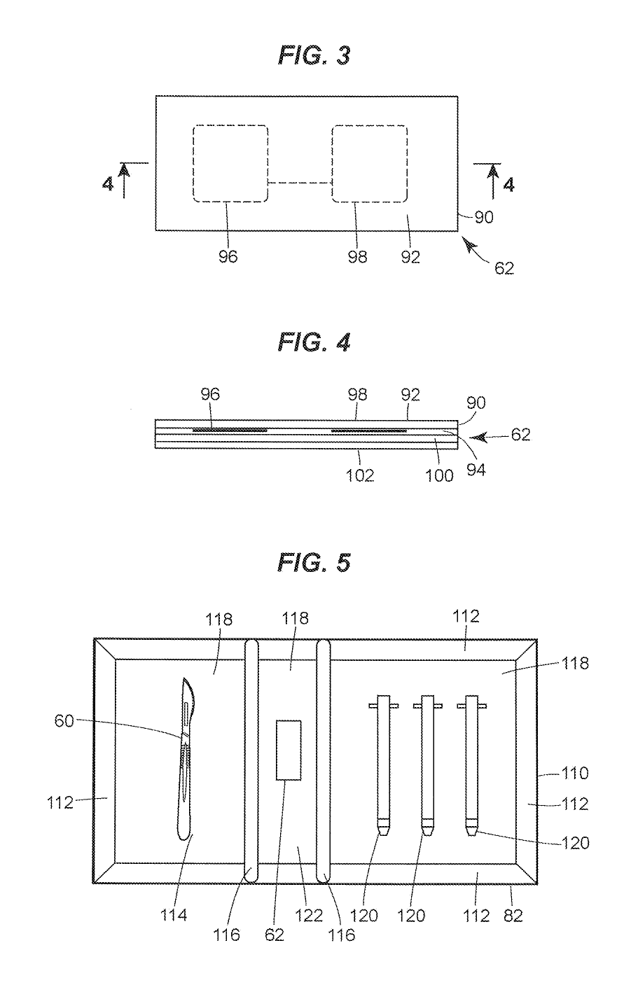

With reference to FIGS. 3 and 4, the RFID tag 62 will have a body 90, a top surface 92, and a bottom surface 94. Within the RFID tag 62 is an antenna 96, and a data module 98 that provides key information to the key reader 82 associated with the computer 72. Affixed to the bottom surface 94 is an adhesive layer 100. Covering the adhesive layer 100 is a removable protective covering 102. After the removable protective covering 102 is removed, the adhesive layer 100 can be used to affix the label containing the RFID tag 62 to the patient record. This information can be stored within the RFID tag 62. The top surface 92 can be printed with an optional legend 104 that can provide information relative to the type of procedure that has been performed and similar information that can be used to complete the patient record for the procedure. In addition, the legend can also include information relative to activation of the license key stored within the RFID tag 62, including information relative to an expiration date of the license key.

FIG. 5 illustrates the accessory kit 50 after the accessory kit 50 has been opened by removing the removable cover 54. The package 52 includes a tray 110 that has sidewalls 112 and a bottom 114. The tray 110 can be divided into compartments 116 by dividers 118. One of these compartments 116 can contain an item such as disposable tracker pins 120. Another compartment 116 can be a key area 122. The RFID tag 62 can be placed within the key area 122.

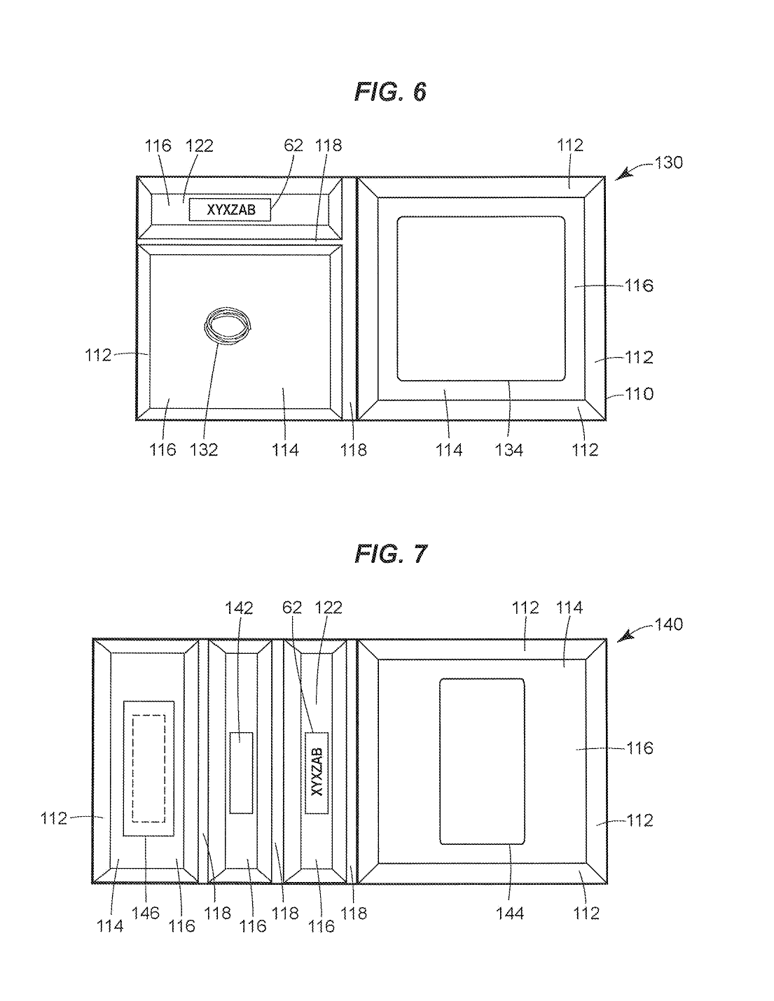

A further embodiment of an accessory kit 130 is illustrated in FIG. 6. The accessory kit 130 can include multiple compartments 116, which can contain the RFID tag 62 with the license key, a suture kit 132, and a disposable sterile drape 134.

For any of the above described kit configurations and for variations thereof, the digital storage media can also contain other information than the activation key and the associated medical application. This could include but is not limited to information related to the contents of the kit, such as items and characteristics, like model and serial numbers. Apart from the kit composition information, other useful information may include the origination of the kit, history of the kit, purpose of the kit, destination of the kit, recipient environment of the kit and eventual deviations of standard usage, disposal information, and the like. In cases where the used media is not able to hold all of the relevant information, keys to remotely accessible data storage locations can be stored instead, such as the location of the information on a hard disk of a computer, an alternate physical storage media, or a web address.

FIG. 7 shows a still further embodiment of an accessory kit 140. The accessory kit 140 includes multiple compartments 116 containing a battery 142, a mask 144, and a container 146 that contains a material that can be used to treat a condition, assist in performing the procedure, or some other material that can be used with the procedure, such as intravenous fluid, a medicament, or both.

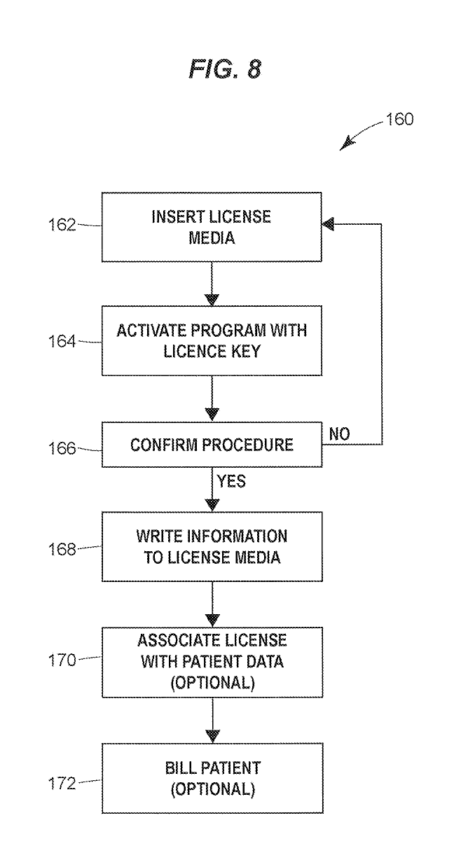

In FIG. 8, a flow diagram 160 shows the steps of a method of one embodiment of the present invention. A block 162 prompts a user to insert media that includes a license key, such as by opening the accessory kit 50 that includes a license key to perform a particular desired procedure using a medical recourse and inserting the media into a reader associated with the computer to perform the procedure. A hospital or other medical facility will typically have a supply of accessory kits 50 on hand. If there are a number of different procedures that can be performed using the same equipment, the hospital will have different accessory kits 50 for each procedure. The license key is used at a block 164 to activate the software based medical resource. As noted above, this is done by entering the license key data contained on the license media into a computer 72 associated with the medical resource. After the license key is entered into the computer 72 as described in the various embodiments noted above, in a preferred embodiment of the method of the present invention, the user will be asked at a block 166 to confirm the procedure the user intends to perform using the medical resource. If the user confirms the procedure that has been entered, control will pass to a block 168 that will write information back to the media that includes the license key. The data that can be written back to the media includes data that will disable the license key, data that is patient specific, data that is procedure specific, and/or some other useful and/or suitable data relative to the procedure or device. In certain instances, the data could be write protecting the media. In order to be secure, a subsequent user should not be able to reverse the write protect state of the media. Therefore, in this environment, the media should be permanently write protected. If the user does not confirm the chosen procedure associated with the license key, the control will pass back to the block 162 that will again ask the user to insert the license media that contains the license key data.

In certain embodiments, it may be desirable to also have the license key associated with a patient record at a block 170. This can be done in a number of methods. One method as described above is to affix the license key to the patient record using adhesive or similar methods to attach the key directly to the patient record. Alternatively, the key can be associated by digitally sending information through a network that can be attached to the computer 72 and the medical or other facility. Lastly, the data can be associated by copying the information to the record by hand. As a further optional set at a block 172, the patient can be billed by the accounting group at the medical facility. The patient can be charged for the cost associated with obtaining the key and using the resource. Typically, the cost can be lower because the facility can more efficiently utilize the resource by having one resource that can perform a number of different procedures.

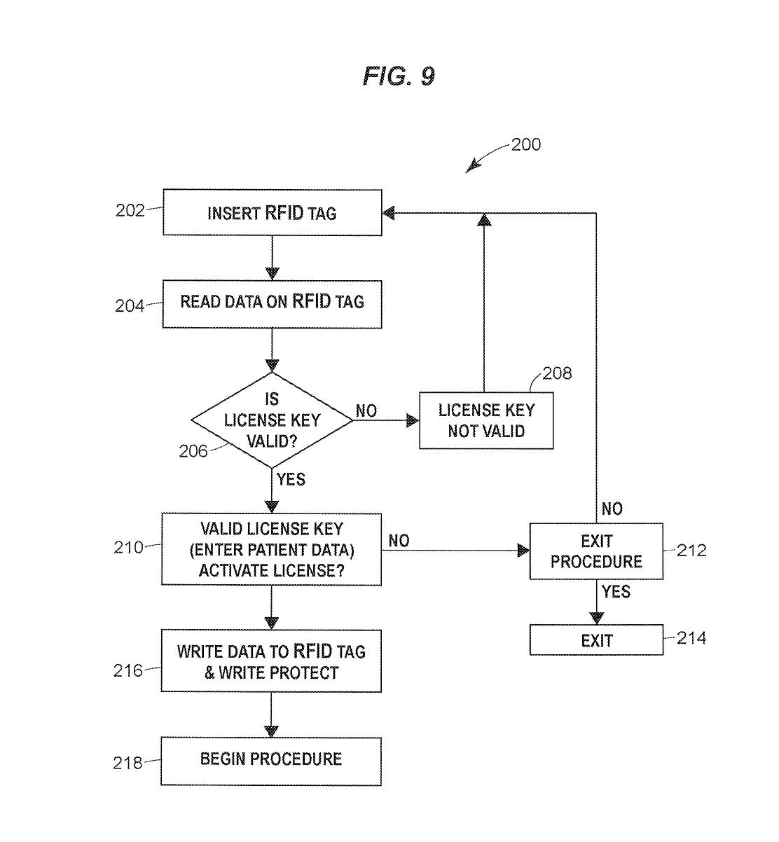

FIG. 9 is a flow diagram 200 of a further embodiment of the present invention. A block 202 displays a message to the user to insert an RFID tag 62 that contains a license key. The RFID tag 62 is read at a block 204 and data from the RFID tag 62 is transferred to the computer 72. The RFID tag 62 can contain a wide variety of information. Typically this information will relate to the particular procedure that is identified on the RFID tag 62, and also on the accessory kit from which the RFID tag 62 was obtained. This information may include the nature of the procedure, information about the other components of the accessory kit, information about the latest update to software that is associated with the particular procedures covered by the license key, encrypted license key information, the identity of the RFID tag 62, and other related information. At a block 206, the computer 72 will determine if the license key data on the RFID tag 62 is valid by comparing the encrypted license key with the data that identifies the RFID tag 62, and also the computer 72 will determine if the RFID tag 62 has data that indicates that the license key had been previously activated and therefore is not currently valid. In one embodiment, the encrypted license key will include some or all of the data that identifies the RFID tag 62 and the computer 72 will compare the data identifying the RFID tag 62 that has been read directly from the RFID tag 62 with the data relating to the RFID tag 62 obtained from the license key. If the data do not match, the block 206 will branch by the No loop to a block 208 that displays a warning message to the user, and control will branch back to the block 202.

If the block 206 determines that the license key is valid, control will pass by a Yes branch to a block 210 that displays a message to the user that a valid license key has been identified. At this point the RFID tag 62 is read write capable, and the user either now or previously may write data directly to the RFID tag 62 that identifies the details of the procedure to be performed. This data may include the identity of the patient, the time and date of the procedure, the identity of the medical facility that is performing the procedure, and other useful information relating to the specific medical procedure to be performed. The block 210 may in certain embodiments prompt the user to enter the above noted information or other information. The block 210 will also ask the user if the user wants to activate the license that has been identified. If the user responds “no,” control will pass by the No branch to a block 212 that asks the user if the user wants to exit the procedure. If the user answers “no,” control will pass by the No branch to the block 202. If the user responds “yes,” then control will pass to a block 214 that exits the procedure. If the user answers “yes” to the question in the block 210, control will pass to a block 216 that writes data to the RFID tag 62 that indicates that the license key has been used and at the same time write protects the RFID tag 62 so that the data indicating that the license key has been used cannot be tampered with or changed. In some embodiments, the users will be asked to confirm that the license key is to be used before the data is written back to the RFID tag 62 and the RFID tag 62 is write protected. After the RFID tag 62 has been write protected, control will pass to a block 218 that begins the procedure that has been chosen. It is possible that the same RFID tag 62 could be used to activate the license for a number of different procedures. In this instance, the display in the block 210 will also prompt the user to choose the particular procedure to be performed. The identity of the chosen procedure will then be part of the data that is written to the RFID tag 62 before the RFID tag 62 is write protected.

By having the RFID tag 62 include data that encrypts the license key that also includes information about the specific RFID tag 62 on which the encrypted license key data is contained, the license key is secure and can be authenticated without the need to access an external network. Further, the writing of data back to the RFID tag 62 and the write protecting of the RFID tag 62 also assist in this secure authentication method.

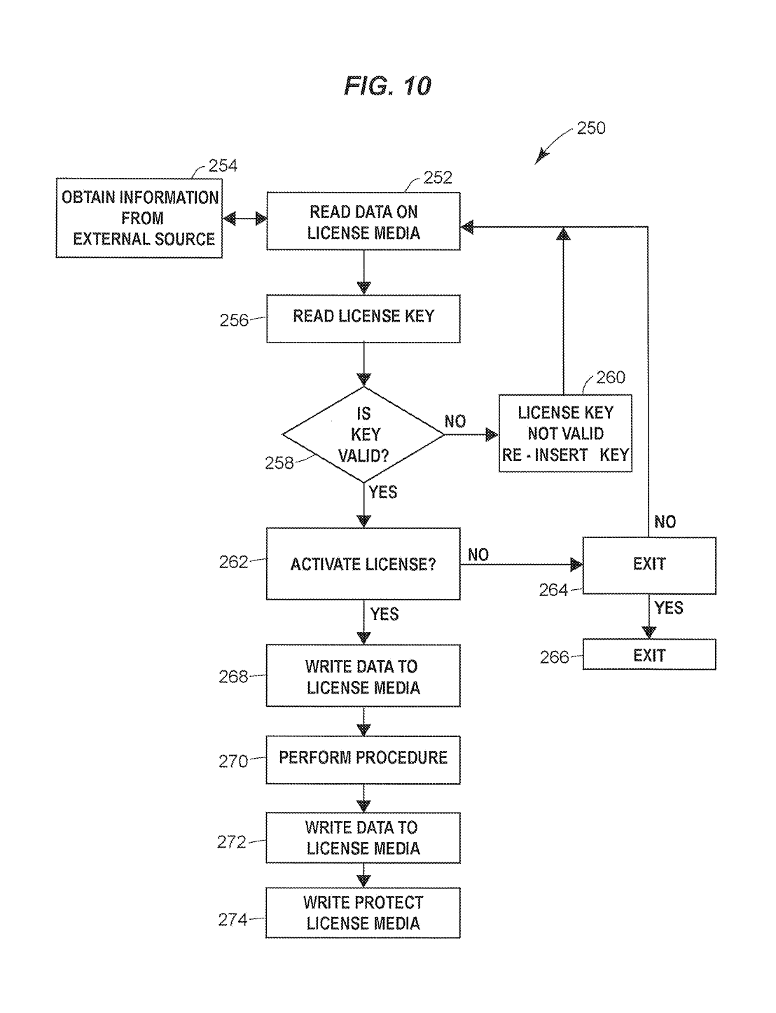

FIG. 10 is a flow diagram 250 of a further embodiment of the present invention. A block 252 reads information from a license media, such as the RFID tag 62. This information can include software update information for the software that is to be licensed, as well as other related useful information. The information can be contained directly within the license media, or as shown in an optional block 254, the license media can include pointers to the location of the information and/or software updates. This pointer can be a file name and location on the medical facility local area network or it can be an address or URL of a site on the Internet, including a web page that has a link to the information and/or update or an address of an FTP server that has the information and/or update. Once the block 254 has received the information from the external source, control passes back to the block 252. If the data indicates that an update to the software or system should be performed, the user will have the opportunity to install or perform the update before proceeding with the process. At this point control then passes to a block 256 that reads the license key information from the license media.

Control then passes to a block 258 that determines if the license key information is valid. This is done is a manner similar to that described above relative to the block 206. If the license key information is not valid, control passes to a block 260 that displays a warning message and asks that license media with a valid key be provided. Control then passes back to the block 252. If the block 258 determines that the license key information is valid, control passes to a block 262 that requests the user to activate the license. This can be done by asking the user to confirm that the license is to be used for that particular procedure. If the user determines not to activate the license, then control will pass via the NO branch to a block 264 that queries the user if the system should exit or attempt to activate a different license key. For instance, the license key that was chosen could have been for a different procedure than the procedure that was planned. In this case the user will indicate that the system should not exit and control will pass via the NO branch to the block 252. Alternatively, the user may choose to end the procedure at this point and control will bass to a block 266 that exits the procedure. In either of these two instances, the license key information of the license media has not been disturbed and remains valid for a later use.

If the user determines to activate the license, control passes to a block 268. In this embodiment, the block 268 writes data to the license media that indicates that the license key has been accessed. Other data can continue to be written to the license media at this point as well. However, the license key has not been deactivated at this point. Control then passes to a block 270 that proceeds with the medical procedure using the software. At the conclusion of the procedure, control passes to a block 272 that writes further data to the license media. This further data can include patient data, data relative to the procedure that has just been performed, etc. In addition, the data will include data indicating that the license key has been used. After this data has been written to the license media, a block 274 write protects the license media. As above, this protects the license media from being reused. Because the license key has not been deactivated until the procedure has been completed, if the procedure needs to be interrupted for any reason, the software can resume the procedure at that point and continue to the conclusion. Although the license media has pointers or links to external systems, including the Internet, the license key activation and deactivation is done within the interaction of the license media and the software based medical device.

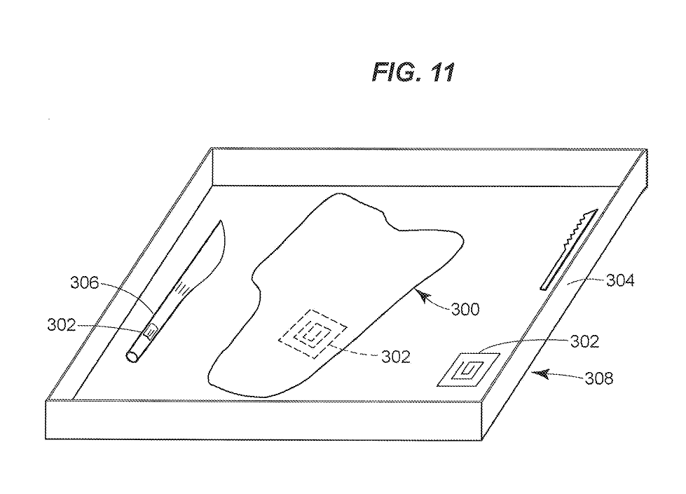

In another embodiment of the invention shown in FIG. 11, a license key for enabling a computer program for use during a medical procedure will be associated directly with an item for use in a specific medical procedure. In one such embodiment, the item will be a medical implant 300 and the license key will be carried by a license media on an RFID tag 302 that is embedded directly in the medical implant. In another such embodiment, the license media will be carried by an RFID apparatus that is not attached to a tag, but will be embedded directly in or on the medical implant 300. In a further such embodiment, the item will include an ancillary device, such as a tracking pin, jig pin, or an instrument tray 304, on which an RFID tag 302 will be secured. In yet a further such embodiment, the license media will be attached to a surgical tool, such as a saw blade or a scalpel 306 that will only be used for that particular surgical procedure and not re-used for any subsequent surgical procedures. In any of these embodiments, the license key will function in any manner as previously described above to allow the medical personnel to use the computer program for a limited number of medical procedures, such as only a single medical procedure, before having to obtain another license key. Therefore, the license media may be associated with a single-use or consumable item, although the license media may also be associated reusable items. The license media in one embodiment will include the ability to store other data, such as information about the specific medical procedure, patient, medical personnel, etc., for future access and reading. If the license media is on, for example, the item that is implanted in a patient, then the other data will always be with the patient in the future and may be accessible, such as in preparation for or during a subsequent medical procedure, but a new license key would still need to be obtained in order to operate the computer program. In one embodiment, the item may be provided in a kit 308 along with other items to be used during the specific medical procedure, such as surgical tools and/or implant devices, carried within a single package, such as the tray 304, and in another embodiment, the item may be provided on its own.

### INDUSTRIAL APPLICABILITY

The accessory kits, items, and methods described herein may allow a medical professional, such as a doctor or veterinarian, to maximize efficient use of overhead resources by enabling installation of medical software, such as for specific medical procedures on humans and/or other animals, on multiple devices, but only pay license fees on the actual use of each particular device. Numerous modifications to the present invention will be apparent to those skilled in the art in view of the foregoing description. Accordingly, this description is to be construed as illustrative only and is presented for the purpose of enabling those skilled in the art to make and use the invention and to teach the best mode of carrying out same. The exclusive rights to all modifications which come within the scope of the appended claims are reserved.

We claim:

1. An accessory kit for use with a software based medical resource to perform a particular medical procedure on a patient, wherein the accessory kit comprises:
a package;
an item for use in performing the particular medical procedure packaged within the package; and
a license media containing a license key that enables a user to use the medical resource to perform the particular medical procedure that includes using the item associated with the procedure, the license media packaged within the package.

2. The accessory kit of claim 1, wherein the license media is an RFID tag.

3. The accessory kit of claim 2, wherein an adhesive is affixed to one side of the RFID tag, and the adhesive is covered by a removable protective layer.

4. The accessory kit of claim 1, wherein the license media is adapted to be detached from the accessory kit and stored for later usage.

5. The accessory kit of claim 4, wherein the license media is adapted to be later used to recall a plurality of different records.

6. The accessory kit of claim 5, wherein at least one of the records is selected from the group comprising patient information, operation information, and financial information.

7. The accessory kit of claim 1, wherein the item is disposable.

8. The accessory kit of claim 1, wherein the item is consumable.

9. The accessory kit of claim 1, wherein some of the items within the package are sterile.

10. The accessory kit of claim 1, wherein the item comprises an ancillary device used to perform a surgical procedure.

11. The accessory kit of claim 10, wherein the disposable item is a pin to affix a tracking device to a patient.

12. The accessory kit of claim 1, wherein the item comprises an implant device.

13. The accessory kit of claim 1, wherein the license media is embedded in the item.

14. The accessory kit of claim 2, wherein the RFID tag includes visual identification data.

15. The accessory kit of claim 8, wherein the visual identification data identifies a procedure that can be licensed by the license key.

16. The accessory kit of claim 2, wherein the license key is encrypted.

17. The accessory kit of claim 2, wherein the RFID tag has RFID tag identification data, and the license key incorporates the RFID tag identification data.

18. The accessory kit of claim 1, wherein the license key allows the user to perform the procedure at most one time using that particular license key.

19. The accessory kit of claim 1, wherein the software based medical resource comprises a surgical navigation system.

20. An item for use with a software based medical resource to perform a particular medical procedure on a patient, wherein the item comprises:
a license media that contains a license key to enable a user to use the medical resource to perform the particular medical procedure on the patient that includes using the item.

21. The item of claim 20, wherein the item is ancillary to the medical procedure.

22. The item of claim 20, wherein the item is an implant device.

23. The item of claim 20, wherein the license media is embedded within the item.

24. The item of claim 20, wherein the license media is secured on a surface of the item.

25. The item of claim 20, wherein the license media is an RFID tag.

26. The item of claim 20, wherein the software based medical resource comprises a surgical navigation system.

27. The item of claim 20, wherein the license key is contained within data on an RFID tag.

28. The item of claim 27, wherein the RFID tag has visual identification data.

29. The item of claim 28, wherein the visual identification data identifies a procedure that can be licensed by the license key.

30. The item of claim 27, wherein the license key is encrypted.

31. The item of claim 27, wherein the RFID tag has RFID tag identification data and the license key incorporates the RFID tag identification data.

32. The item of claim 27, wherein the license key is encrypted and the software based medical resource authenticates the license key using identification data carried by the RFID tag.

33. The item of claim 20, wherein the license key allows the user to perform the procedure one time.

34. A method of licensing the use of a software based medical resource to perform a particular procedure, the method comprising the steps of:
obtaining a license key from a license media;
using the key to activate a medical resource; and
writing data back to the license media to disable the license key so that the license key can not be reused.

35. The method of claim 34, wherein the license media is an RFID tag.

36. The method of claim 35, wherein the RFID tag can be write protected.

37. The method of claim 36, wherein the data written to the RFID tag indicates that the license key has been used.

38. The method of claim 35, wherein the RFID tag has RFID tag identification data, and the license key incorporates the RFID tag identification data.

39. The method of claim 34 that includes the step of authenticating the license key within the license media without accessing an external network.

40. The method of claim 34 that includes the step of associating the license key with a record of a patient on which the medical resource was used.

41. The method of claim 40, wherein the step of associating the license key is performed by affixing the license key to the patient record.

42. The method of claim 34 that includes the step of confirming the particular procedure.

43. The method of claim 34 that includes the step of performing the particular procedure before the step of writing data back to the license media.

44. The method of claim 34, wherein the license media includes links to external sources of information.

45. The method of claim 34, wherein the license key comprises storage media, and wherein the storage media also holds other information.

46. The method of claim 45, wherein the other information is relevant to the particular procedure.

47. The method of claim 45, wherein the other information is relevant to history of a device that is associated with performing the particular procedure.

48. The method of claim 47, wherein the other information is not stored directly on the storage media.

49. The method of claim 47, wherein the other information is stored directly on the storage media.
